(19) United States
(12) Patent Application Publication
(10) Pub. No.: US 2009/0299825 A1
(43) Pub. Date: Dec. 3, 2009

(54) SALES LEAD MANAGER AND FILTER WITH RANDOMIZER

(76) Inventors: Jonathan Olawski, Scottsdale, AZ (US); Gary Bialowas, Scottsdale, AZ (US)

Correspondence Address: Kunzler & McKenzie, 8 EAST BROADWAY, SUITE 600, SALT LAKE CITY, UT, 84111, US

(21) Appl. No.: 12/477,793

(22) Filed: Jun. 3, 2009

Related U.S. Application Data
(60) Provisional application No. 61/058,508, filed on Jun. 3, 2008.

(51) Int. Cl. G06Q 30/00; G06F 17/30; G06Q 10/00

(52) U.S. Cl. 705/10; 707/3; 707/E17.014

(57) ABSTRACT

A computer implemented method for automatically managing and delivering sales leads to a seller of a product. the steps of said method comprising 1) receiving a sales lead comprising information about a potential customer; 2) applying one or more query expressions to the information, the query expressions comprising a Boolean condition and one or more parameters; 3) applying one or more random query expressions to the information, the random query expressions comprising a Boolean condition and one or more parameters defined by the third-party manager; 4) setting a lead value indicator associated with the sales lead in response to the sales lead; and 5) regulating delivery of the sales lead to one or more seller clients in response to the lead value indicator satisfying a minimum priority level.

### CROSS-REFERENCES TO RELATED APPLICATIONS

This application claims priority to U.S. Provisional Patent Application No. 61/058,508 entitled SALES LEAD MANAGER AND FILTER WITH RANDOMIZER and filed on Jun. 3, 2008 for Jonathan Olawski and Gary Bialowas, which is incorporated herein by reference.

### BACKGROUND

1. Field of the Invention

This invention relates to computer systems, more particularly using a computer system to determine a seller for a sales lead.

2. Description of the Related Art

Historically sales people of service industries have used traditional advertising venues such as phone books and billboards to procure customers. For example, a service provider may purchase advertisement space in a phone book (e.g. YELLOW PAGES) and when a potential customer sought that particular service, they would see the contact information for the service provider and possibly contact the service provider. In this example, the phone book advertisement generated a sales lead, which the service provider was able to pursue. Generally, by looking in a local listing like a phone book, there was a high likelihood that the service provider would be able to provide the services sought by the customer.

However, with the rise of the Internet, more people are looking to the Internet to search for services. Following the possible customers, service providers have created internet sites that help them generate sales lead. However, the internet is global, and service providers may be incapable of serving potential customers who contact them through the internet. For example, a service provider may receive a request to provide services for someone who lives far from the service provider. Because of the incompatibility of the service requests, the service provider frequently must reject potential customers, wasting both the time of the customer and the service provider.

### SUMMARY

From the foregoing discussion, it should be apparent that a need exists for an apparatus, system, and method to manage sales leads. It is the object of the present invention to provide such a method and system.

The present invention has been developed in response to the present state of the art, and in particular, in response to the problems and needs in the art that have not yet been fully solved. Accordingly, the present invention has been developed to provide an apparatus, system, and method for managing sales leads that overcome many or all of the above-discussed shortcomings in the art.

The apparatus to manage sales leads is provided with a plurality of modules configured to functionally execute the necessary steps of managing sales leads. These modules in the described embodiments include a reception module configured to receive a sales lead comprising information about a potential customer; an application configured to apply one or more query expressions to the information; a randomizing module for randomly applying one or more random query expressions to the information; a setting module configured to set a lead value indicator associated with the sales lead in response to the sales lead satisfying one or more of: the one or more query expressions, and the one or more random query expressions; and a regulating module configured to regulate delivery of the sales lead to one or more seller clients in response to the lead value indicator.

A method of the present invention is also presented for automatically managing the delivery of sales leads. The method in the disclosed embodiments substantially includes the steps necessary to carry out the functions presented above with respect to the operation of the described apparatus and system. In one embodiment, the method includes receiving a sales lead comprising information about a potential customer, said information comprising one or more of: age, address, gender, credit rating, email, telephone number, commercial or residential nature, title in residence, size of residence, price of residence, income, education, purchasing interests, and purchasing practices; applying one or more query expressions to the information, the query expressions comprising a Boolean condition and one or more parameters, the parameters of each query expression being predefined by one or more of: a seller in the database, a third-party manager, and a model comprising historical analysis of previous sales leads; randomly applying one or more random query expressions to the information, the random query expressions comprising a Boolean condition and one or more parameters defined by the third-party manager; setting a lead value indicator associated with the sales lead in response to the sales lead satisfying one or more of: the one or more query expressions, and the one or more random query expressions; and regulating delivery of the sales lead to one or more seller clients in response to the lead value indicator satisfying a minimum priority level.

The method may further comprise assembling the sales lead into a sales campaign in response to the sales lead satisfying the one or more query expressions. The method may also comprise delivering the sales campaign to one or more seller clients in a priority queue.

In another embodiment, setting a lead value indicator may comprise setting a plurality of lead value indicators each associated with a different seller client in a seller client database. Further, the method may comprise determining a distance between the potential customer associated with the sales lead and a seller associated with the seller client in a seller client database.

In certain embodiments, the method may further comprise an operation to notify one or more seller clients of the receipt of the sales lead. The method may also apply a subsequent set of one or more query expressions to the information, the subsequent query expressions comprising a Boolean condition and one or more parameters, the parameters of each subsequent query expression being predefined by one or more of: a subsequent seller client in the priority queue, a third-party manager, or a model comprising historical analysis of previous sales leads.

In another embodiment, the method may comprise systematically repeating the application step for each seller client in a seller client database while the repeating step has not been applied for all seller clients in the seller client database until one or more query expressions are satisfied. The method may also apply a randomizing factor to the sales leads that failed to satisfy the one or more query expressions to determine which seller client in the seller client database should receive the sales lead. Further, the method may store information on a computer readable file on a computer readable storage device, wherein the regulating step regulates delivery of the sales lead over a computer network.

In certain embodiments, a computer program product comprising a computer-readable medium having computer usable program code executable to perform operations for automatically managing and delivering sales leads to a seller of a product, the operations of the computer program product may comprise receiving a sales lead comprising information about a potential customer, said information comprising one or more of: age, address, gender, credit rating, email, telephone number, commercial or residential nature, title in residence, size of residence, price of residence, income, education, purchasing interests, and purchasing practices; applying one or more query expressions to the information, the query expressions comprising a Boolean condition and one or more parameters, the parameters of each query expression being predefined by one or more of: a seller in the database, a third-party manager, and a model comprising historical analysis of previous sales leads; applying one or more random query expressions to the information, the random query expressions comprising a Boolean condition and one or more parameters defined by the third-party manager; setting a lead value indicator associated with the sales lead in response to the sales lead satisfying one or more of: the one or more query expressions, and the one or more random query expressions; and regulating delivery of the sales lead to one or more seller clients in response to the lead value indicator satisfying a minimum priority level.

The computer-readable storage media may also assemble the sales lead into a sales campaign in response to the sales lead satisfying the one or more query expressions. Further, The computer-readable medium may cause the computing device to deliver the sales campaign to one or more seller clients in a priority queue.

In another embodiment, the computer-readable storage media may cause the computing device to set a plurality of lead value indicators each associated with a different seller client in a seller client database. Further, computer-readable storage media may cause the computing device to determine a distance between the potential customer associated with the sales lead and a seller associated with the seller client in a seller client database.

The computer-readable storage media may cause the computing device to notify one or more seller clients of the receipt of the sales lead and may cause the computing device to apply a subsequent set of one or more query expressions to the information, the subsequent query expressions comprising a Boolean condition and one or more parameters, the parameters of each subsequent query expression being predefined by one or more of: a subsequent seller client in the priority queue, a third-party manager, or a model comprising historical analysis of previous sales leads.

In certain embodiments, the computer-readable storage media may further cause the computing device to systematically repeat the application step for each seller client in a seller client database while the repeating step has not been applied for all seller clients in the seller client database until one or more query expressions are satisfied. The computer-readable storage media may also cause the computing device to apply a randomizing factor to the sales leads that failed to satisfy the one or more query expressions to determine which seller client in the seller client database should receive the sales lead.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a computer system that manages and filters sales leads in accordance with the present invention;

FIG. 2A is a diagram illustrating one embodiment of a sales campaign comprising multiple sales leads structured within a computer readable file;

FIG. 2B is a block diagram illustrating a plurality of sales campaigns comprising sales leads organized in accordance with the present invention;

FIG. 3 is a schematic block diagram illustrating one embodiment of a sales lead manager and filter with randomizer in accordance with the present invention;

FIG. 4A depicts a bitwise operation included in one embodiment of a sales lead manager and filter in accordance with the present invention;

FIG. 4B depicts a basic filtering algorithm embodied in a computer program product subroutine shown in C syntax with variable declarations in accordance with one embodiment of the present invention; and

FIG. 5 is a flow chart of a method of managing and filtering sales leads in accordance with one embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

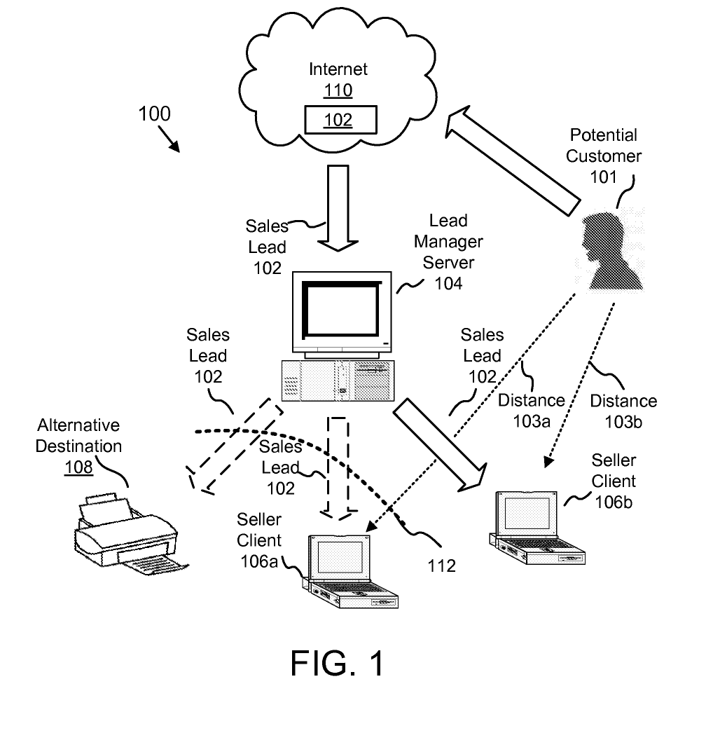

FIG. 1 is a block diagram illustrating one embodiment of a computer system 100 that manages and filters sales leads in accordance with the present invention. FIG. 1 comprises a potential customer 101, and a computer system 100, which computer system 100 comprises a sales lead 102, a distance 103a, a distance 103b, a lead manager server 104, a seller client 106a, a seller client 106b, an alternative destination 108, an Internet 110, and a virtual barrier 112.

The potential customer 101 may be any person, company or organization that is potentially a customer of another person, company or organization.

The sales lead 102, in this embodiment, is a computer readable file, where the computer readable file is transmittable over a signal bearing medium and storable on a computer readable storage. The sales lead 102 comprises information about a potential buyer of a service or product, in this case, about the potential customer 101. The information may be generated or collected through any number of processes as are well-known to those of skill in the art, including through cost-per-click (CPC) advertising or cost-per-impression (CPI) advertising on the Internet 110; through telephonic discussions initiated by the potential customer 101, the seller clients 106a-b, or another party; email solicitations; direct mailers; and the like. In the shown embodiment, the sales lead 102 comprises information generated through directed advertising on the Internet 110 and collected by the lead manager server 104.

In some embodiments, the information constituting the sales lead 102 may comprise a lead value indicator, settable by the lead manager server 104 to indicate the seller client 106a-b to whom the sales lead 102 is scheduled for delivery. Alternatively, the lead value indicator may be settable by the lead manager server 104 to indicate a general estimated value of the sales lead 102 to the seller clients 106a-b in communication with the lead manager server 104. The information may further comprise a request for the sales lead 102 itself by a seller client 106a-b, or a request for more general information such as whether any sales leads 102 are available for transmittal which meet a criteria predetermined by the seller clients 106a-b or by the lead manager server 104.

The distance 103a, in the shown embodiment, is the radial geographic distance between a seller associated with seller client 106a and the potential customer 101 in miles or kilometers.

The distance 103b, in the shown embodiment, is the radial geographic distance between a seller associated with seller client 106b and the potential customer 101 in miles or kilometers.

In the shown embodiment, the lead manager server 104 comprises a computer program product running on one or more data processing devices (DPDs), such as a server, computer workstation, router, mainframe computer or the like. In various embodiments, the DPD comprises one or more processors. The processor is a computing device well-known to those in the art and may include an application-specific integrated circuit (“ASIC”).

In the present invention, the lead manager server 104 may route the sales lead 102 to any DPD, device, person, company, organization, or the like in communication with the lead manager server 104, such as the seller clients 106a-b.

In this embodiment, the lead manager server 104 notifies the seller clients 106a-b via email that sales leads 102 are available for download or transmittal. In other embodiments, the seller clients 106a-b request information from the lead manager server 104 over a distributed network to which the seller clients 106a-b and lead manager server 104 are mutually coupled. In various embodiments, a large plurality of seller clients 106 may be in logical communication with the lead manager server 104 through a networked environment, such as local area network (LAN) or wide area network (WAN).

The predetermined criteria, as determined by either the seller clients 106a-b and/or the lead manager server 104, comprises one or more logical filters, or query expressions, which the lead manager server 104 applies to the information in the sales lead 102 to determine the one or more seller clients 106 to whom the sales lead 102 should be relayed. In some embodiments of the present invention, the predetermined criteria may affect the manner in which the sales lead 102 is generated, such as through collection activities on the Internet 110 or in other mediums, including bid amounts on certain keywords in CPC and/or CPI advertising.

The lead manager server 104 may apply, in various embodiments, a plurality of particularized predetermined criteria sequentially for each of seller clients 106a-b to the sales lead 102 in an order specified in a priority queue managed by the lead manager server 104. In various embodiments, seller clients 106a-b may bid on, or otherwise pay for, priority positions in the priority queue.

By way of example, in the shown embodiment, the seller associated with seller client 106a is located at a distance 103a of four-hundred (400) miles in a radial direction from the potential customer 101 described in the sales lead 102. The seller associated with seller client 106b is located at only a distance 103b of fifty (50) miles in a radial direction from the potential customer 101. If both seller clients 106a-b have predefined in a predetermined criteria that the maximum radial distance, within which sales leads qualify for acceptance, is seventy-five (75) miles, then the sales lead will be sent to seller client 106b, as shown in FIG. 1.

In the shown embodiment and in the recited example, the seller client 106b receives the sales lead 102 from the lead manager server 104 because seller client 106b is located fifty (50) miles from the potential customer 101, within the maximum radial distance. The seller client 106a does not receive the sales lead 102. The result is the same if the lead manager server 104 has predefined the maximum radial distance from seller clients 106a-b to be seventy-five (75) miles.

If, in the shown embodiments, both seller clients 106a-b were located within the predefined maximum radial distance, but seller client 106a was higher in the priority queue, seller client 106a would receive lead 106a from the lead manager server 104 because the seller client 106a's predetermined criteria would be applied first.

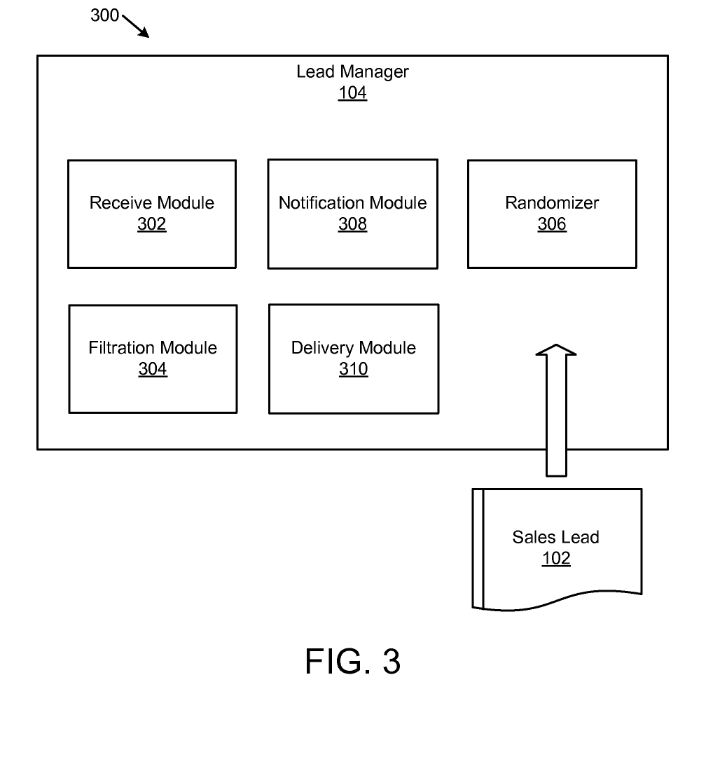

As further described in FIGS. 3-5 below, in various embodiments, any number of predetermined criteria comprising one or more logical filters, or query expressions, are applied by the lead manager server 104 to information in the sales lead 102 to determine the seller or seller clients 106a-b to whom the sales lead 102 should be delivered.

The seller clients 106a-b, in this embodiment, comprise DPDs configured to interact with a user through a graphical user interface (GUI) coupled to the DPD. The user may be a salesman or sales representative, or an agent thereof, who contacts the potential customer 101 by phone, email, facsimile or the like. The seller clients 106a-b are configured to retrieve and/or receive the sales lead 102 from, or through, the lead manager server 104. In some embodiments, the seller clients 106a-b may be configured to receive the sales lead 102 as an email attachment using variations of the Simple Mail Transfer Protocol (SMTP), Internet Message Access Protocol (IMAP), Post Office Protocol (POP), or other protocols well-known to those of skill in the art.

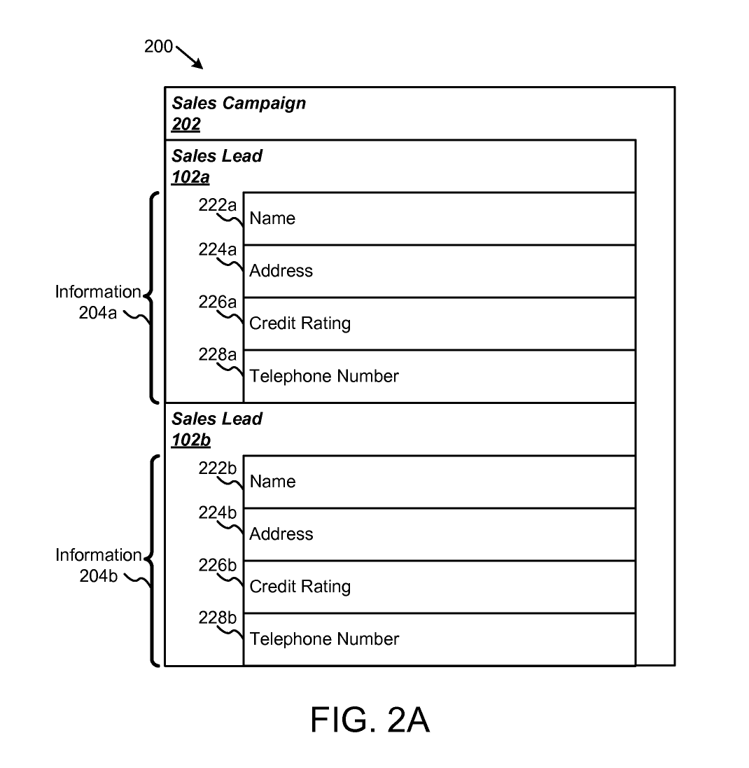

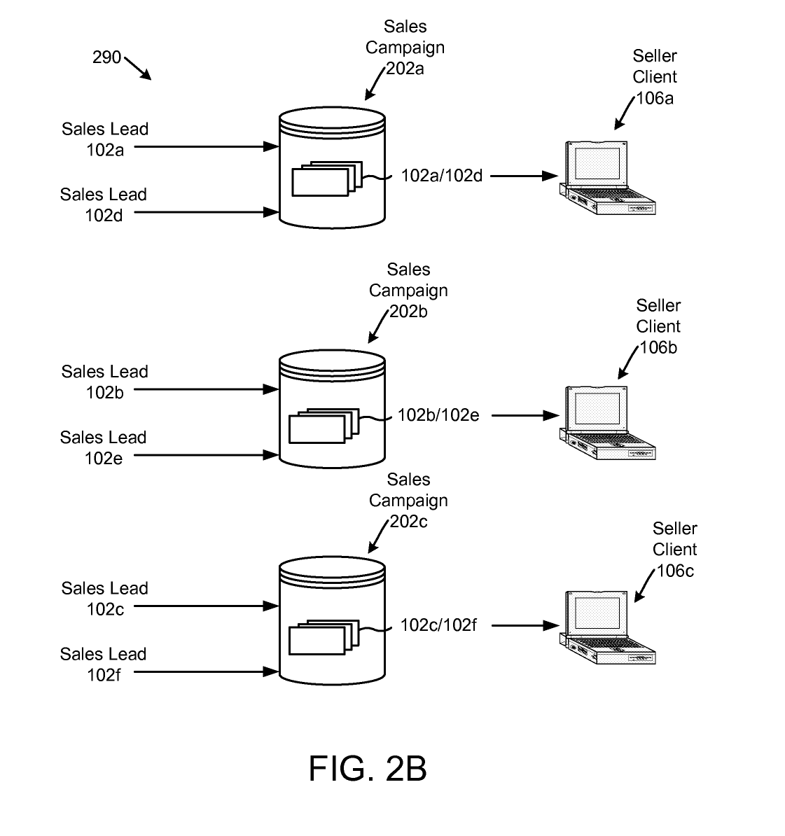

In some embodiments, the seller clients 106a-b, in communication with the lead manager server 104, may be assigned a unique identifier. For sales leads 102 that satisfy the predetermined criteria of a particular seller client 106, the lead manager server 104 may set the lead value indicators to indicate the seller client 106 to whom the sales lead 102 is scheduled for delivery, or may set the lead value indicators in such a manner as to facilitate the collection of all sales leads 102 satisfying a predetermined criteria for a particular seller client 106a-b into a sales campaign (described further below in relation to FIG. 2A-2B).

The alternative destination 108, in this embodiment, is a printer in logical communication with the lead manager server 104. In the case of the alternative destination 108, the sales lead 102 may ultimately be routed to paper dispensed from a printer in response to the sales lead 102 not satisfying any of the logical filters in the predetermined criteria (e.g., in the foregoing example, if the distance 103a and distance 103b both exceed 400 miles).

In other embodiments, the alternative destination 108 may comprise a computer readable storage, or even a software module which randomly relays a sales lead 102 to one of the seller clients 106a-b as further described in subsequent figures.

The virtual barrier 112 is illustrative of the shielding effect the predetermined criteria has, in this embodiment, on the seller client 106a and the alternative destination 108. The logical filtering by the lead manager server 104 prevents the seller client 106a and the alternative destination 108 from receiving the sales lead 102.

Referring now to FIG. 2A, a computer program product comprising a computer readable file 200 stored on a tangible medium. FIG. 2A depicts one embodiment of a sales campaign 202, the sales campaign 202 comprising a sales lead 102a, a sales lead 102b, information 204a, information 204b, a name 222a, a name 222b, an address 224a, an address 224b, a credit rating 226a, a credit rating 226b, a telephone number 228a, and a telephone number 228b.

The sales campaign 202 comprises a record of one or more sales leads 102a-b. The sales campaign preferably comprises a structured computer-readable file, but may also comprise a book, digital image, video, audio recording, or the like. The sales campaign 202 may comprise a relational computer database managed by a relational database management system (RDBMS) or a database management system (DBMS), such as Oracle, DB2, Firebird, SQL, or other DBMSs as well-known to those of skill in the art.

The sales campaign 202 may comprise all sales leads 102a-b generated over a predefined or undefined period of time, or only those sales leads 102a-b that satisfy a predetermined criteria (explained in further detail in FIGS. 3-5). The sales campaign 202 may alternatively or additionally comprise only those sales leads 102a-b scheduled for delivery to one or more of a plurality of seller clients, such as seller clients 106a-b.

Referring now to FIG. 2B, a system for managing and filtering sales leads. FIG. 2B is a block diagram illustrating a plurality of sales campaigns comprising sales leads organized in accordance with the present invention. The system 290 includes a sales campaign 202a, a sales campaign 202b, a sales campaign 202c, seller clients 106a-c, and sales leads 102a-f.

In the embodiment, each of the sales campaigns 202a-c comprises structured computer-readable files organized and indexed in a database and saved in computer-readable storage. Each of the sales campaigns 202a-c comprises sales leads 102a-f that have satisfied a predetermined criteria for one of the seller clients 106a-c. The storage comprising the sales campaigns 202a-c may be coupled to the lead manager server 104 for later transmission to the seller clients 204a-c, or the sales campaigns 202a-c may be coupled to DPDs representing, or under the control of, the seller clients 106a-c.

In this embodiment, the seller clients 106a-c are each subscribers of the lead manager server 104, substantially described above. Sales leads 102a-f are also described substantially above in relation to FIG. 1. The sales leads 102a-f are not organized sequentially in the shown example because they are distributed to sales campaigns 202a-c without regard to the order in which they were collected.

Referring now to FIG. 3, an apparatus 300 for managing and filtering sales leads. FIG. 3 is a schematic block diagram illustrating one embodiment of a sales lead manager server and filter with randomizer in accordance with the present invention. The apparatus 300 includes a lead manager server 104 comprising a receive module 302, a filtration module 304, a randomizer 306, a notification module 308, a delivery module 310, and a sales lead 102.

The receive module 302 is configured to receive the information comprising the sales lead 102 from other sources as described above in relation to FIG. 1. The receive module 302 may receive the entire sales lead 102 in the form of a computer file, or may receive the information constituting the sales lead 102 in pieces from the outside data collector, which pieces the receive module 302 uses to generate the sales lead 102. The receive module 302 may be in communication with the data collectors over a communication bus, wirelessly using a scanner or transceiver, or via a network, including the Internet 110. The data collectors may be internal or external to the lead manager server 104. The data collectors may include devices, systems, individuals, or the like, which convey the sales lead 102, in whole or in part, in real time or delayed time, to the lead manager server 104 for later communication to the seller client 106a-c. One of skill in the art will recognize many ways of configuring the receive module 302 to receive and collect the sales lead 102.

The filtration module 306, in various embodiments, is configured to apply any number of predetermined criteria to the information in the sales lead 102 to determine the sales campaign 202, alternative destination 108, seller or seller clients 106a-c to whom the sales lead 102 should be ultimately delivered.

The predetermined criteria represent values, or conditions, with which the information in the sales lead 102 must comply to qualify the sales lead 102 for delivery and is partially described above in relation to FIG. 1. In other embodiments, the predetermined criteria may disqualify a sales lead 102 for delivery. The predetermined criteria may be set by one or more of the seller clients 106a-c, or third-parties managing or in communication with the lead manager server 104.

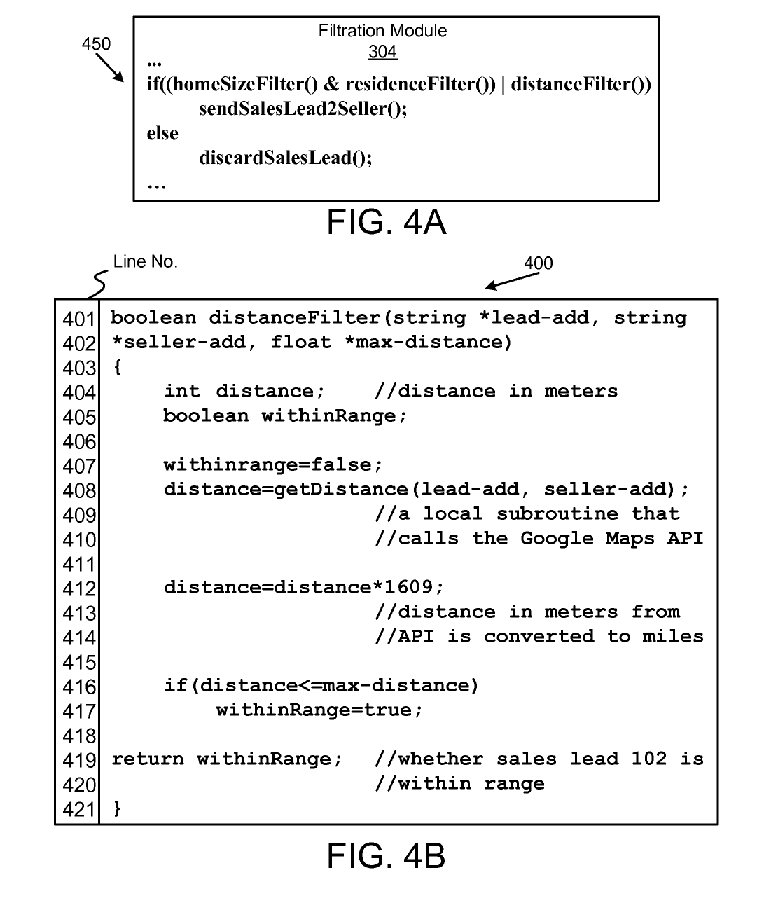

The filtration module 304 is configured to apply a series of logical filters, or query expressions, to the information in the sales lead 102. The filtration module 304 may mark the lead value indicator within the information in the sales lead 102. The lead value indicator, in various embodiments, is controlled by the filtration module 304 to represent the estimated monetary value of the sales lead 102 to one or more seller clients 106a-c based on an historical analysis, and/or to represent the one or more seller clients to which the sales lead 102 is scheduled for delivery. The lead value indicator may represent a degree to which a sales lead 102 satisfies a predetermined criteria rather than a Boolean value indicating only that it does, or does not, satisfy the predetermined criteria. An example of the filtration module 304 is substantially shown and described in relation to FIGS. 4A-4B below.

The randomizer 306 is configured, in some embodiments, to deliver a percentage of sales leads 102 which satisfy no predetermined criterion to seller clients 106a-c under conditions in which seller clients 106a-c would normally not receive said sales leads. The randomizer adds a predetermined degree of randomness to the functions of the delivery module 310 (the predetermined degree of randomness hereinafter “ρ”). The predetermined degree of randomness, ρ, may be defined, in some embodiments, by a third-party manager monitoring and/or managing the operations of the lead manager server 104, or by a seller client 106.

By way of example, if ρ is predetermined to be ten percent (i.e. 0.1 or 10%) and the randomizer 306 is configured to randomly deliver ρ percent of sales leads that fail to satisfy the seller client 106a's predetermined criteria to seller client 106a in spite of the non-satisfaction of the predetermined criteria, then the seller client 106a could expect to receive an estimable number of sales leads 102 in addition to those satisfying the predetermined criteria per the operations of the randomizer 306.

The randomizer 306, by randomly mandating delivery of an estimable numbers of sales leads 102, allows seller clients 106a-c to experimentally gauge the value of sales leads 102 which the seller clients 106a-c may not have anticipated were valuable when establishing their predetermined criteria, or which the seller clients 106a-c excluded from the predetermined criteria intentionally or unintentionally. In other embodiments, the randomizer 306 is configured to favor seller clients 106 in a position of lower priority in the priority queue by delivering ρ percent of sales leads marked as valuable in the lead value indicator to seller clients 106 who would not normally be scheduled to receive said sales leads.

In still further embodiments, the randomizer 306 may randomly alter, or reverse, the results of individual query expressions applied within the filtration module 304 to randomly affect the end determination by the filtration module 304 of whether a sales lead 102 satisfies a predetermined criterion.

The notification module 308 may communicate with the seller clients 106a-c as described above in relation to FIG. 1. In some embodiments, the notification module 308 notifies the seller clients 106a-c that sales leads 102a-f are available for retrieval, and/or that sales campaigns 202a-c are available for retrieval. The notification module 308 may notify the seller clients 106a-c of the availability of the sales lead 102 through any means of digital communication like an enterprise email systems, telephone, facsimile or the like.

The delivery module 310 may deliver the sales lead 102 and/or the sales campaign 202a-c to a seller client 106a-c when the sales lead 102 satisfies a seller client's predetermined criteria. The delivery module 310 is further described above in relation to FIG. 1. In those embodiments in which the lead value indicator represents a degree, the delivery module 310 may deliver the sales lead 102 to a seller client 106a-c when the lead value indicator exceeds a minimum priority level. The seller or a third party may define the minimum priority level to require that the information must satisfy a minimum number of query expressions to qualify for delivery by the delivery module 310.

Referring now to FIG. 4A, a computer program product 450 for managing and filtering sales leads. FIG. 4A depicts a bitwise operation included in one embodiment of a filtration module 306 within the lead manager server 104 in accordance with the present invention. The filtration module 306, in this embodiment, is shown in C syntax comprising two bitwise operations and five subroutine calls, including homeSizeFilter, residenceFilter, distanceFilter, sendSalesLead2Seller, and discardSalesLead.

In this embodiment, three of the five subroutine calls: homeSizeFilter, residenceFilter, and distanceFilter; each apply filters (i.e. query expressions or a predetermined criterion), to parameters comprising one or more of: the names 222, the addresses 224, the credit ratings 226, the telephone numbers 228, and other data in the information 204. These query expressions may comprise any one or more logical or bitwise operation, such as OR, AND, XOR, NOR, NOT, and the like. In this embodiment, all the subroutines use global variables recognized by those of skill in the art.

In the shown embodiment, the filtration module 304 first calls homeSizeFilter, which is a subroutine that verifies that the square footage of a potential customer 101's home is greater than a square footage amount predefined by a seller, such as the seller client 106a. If the square footage is verified, homeSizeFilter returns a true value to the filtration module 304.

In the shown embodiment, the filtration module 304 next calls residenceFilter, which is a subroutine that verifies that the potential customer 101 is a residential customer rather than a commercial customer (or vice-versa in other embodiments). If the potential customer 101 is verified to be a residential customer, homeSizeFilter returns a true boolean value (represented by ‘1’) to the filtration module 304.

In the shown embodiment, the filtration module 304 next calls distanceFilter, which is a subroutine that verifies that the potential customer 101 is located within a predefined maximum radial distance from the seller client 106a. If the radial distance is verified to be less than the predefined maximum radial distance, homeSizeFilter returns the boolean value “true” to the filtration module 304. The distanceFilter is further described below in relation to FIG. 4B.

The filtration module 304 calls the subroutine sendSalesLead2Seller, which is the computer program product equivalent of the delivery module 310. If the homseSizeFilter and the residenceFilter both return a value of true or the distanceFilter returns true, the filtration module calls the subroutine sendSalesLead2Seller which then delivers the sales lead 102 to the seller client 106a.

In this embodiment, if either the homeSizeFilter or the residenceFilter return false (represented by ‘0’), or the distanceFilter returns false, then the filtration module 304 discards the sales lead 102 by calling the subroutine discardSalesLead; which, in the shown embodiment, sends the sales lead 102 to the alternative destination 108 where it is saved on paper.

Referring now to FIG. 4B, a computer program product 400 for managing and filtering sales leads. FIG. 4B depicts a filtering algorithm embodied in a computer executable subroutine shown in C syntax with local variable declarations in accordance with one embodiment of the present invention. The distanceFilter subroutine comprises computer readable instructions 401-421.

In the shown embodiment, the distanceFilter receives three pointers as parameters which point to strings of characters, *lead-add, *seller-add, and *max-distance.

The *lead-add pointer points to, and represents, the address of the potential customer 101 saved as a string.

The *seller-add pointer points to, and represents, the address of the seller client 106a.

The *max-distance pointer points to, and represents, the maximum radial distance in miles within which the potential customer 101 must be located to satisfy the predetermined criterion, predefined in this embodiment by the seller client 106a.

As set forth above, the query expressions applied to the information in the sales lead 102 comprise parameters, including one or more of: any piece of information in the sales lead 102 and a predefined criterion.

Applying this filtering algorithm would produce the result substantially described above, in relation to FIG. 1, if distanceFilter were applied once for seller client 106a and once for seller client 106b.

Where the seller associated with seller client 106b is located 50 radial miles from potential customer 101, the distanceFilter subroutine would receive the sent parameters at 11. 401-402, initialize variables at 11. 404-407, and begin at 1. 408 by calling the separate get Distance subroutine that returns, in this embodiment, the distance in meters between the seller associated with seller client 106b's address and the potential customer 101.

In various embodiments, the getDistance subroutine may be a function internal or external to the lead manager server 104. In the shown embodiment, the getDistance subroutine calls a function provided in the GOOGLE Maps Application Programming Interface (API) over the Internet 110. One of skill in the art will recognize other means of determining the distance in miles between the seller client 106b and the potential customer 101.

The distance returned by getDistance is converted into miles at 1. 412 and checked at 1. 416 to verify that the distance is less than the predefined maximum radial distance specified in the pointer *max-distance, and predefined in this embodiment by the seller client 106b.

In certain embodiments, if the distance is less than the *max-distance, the distanceFilter subroutine returns the boolean value “true” to the filtration module 304, which results in delivery of the sales lead 102 to seller client 106b. In the embodiments shown in FIGS. 4A-4B, the filtration module may withhold the sales lead 102 from the seller client 106a because the seller client 106a is located outside the predefined maximum radial distance.

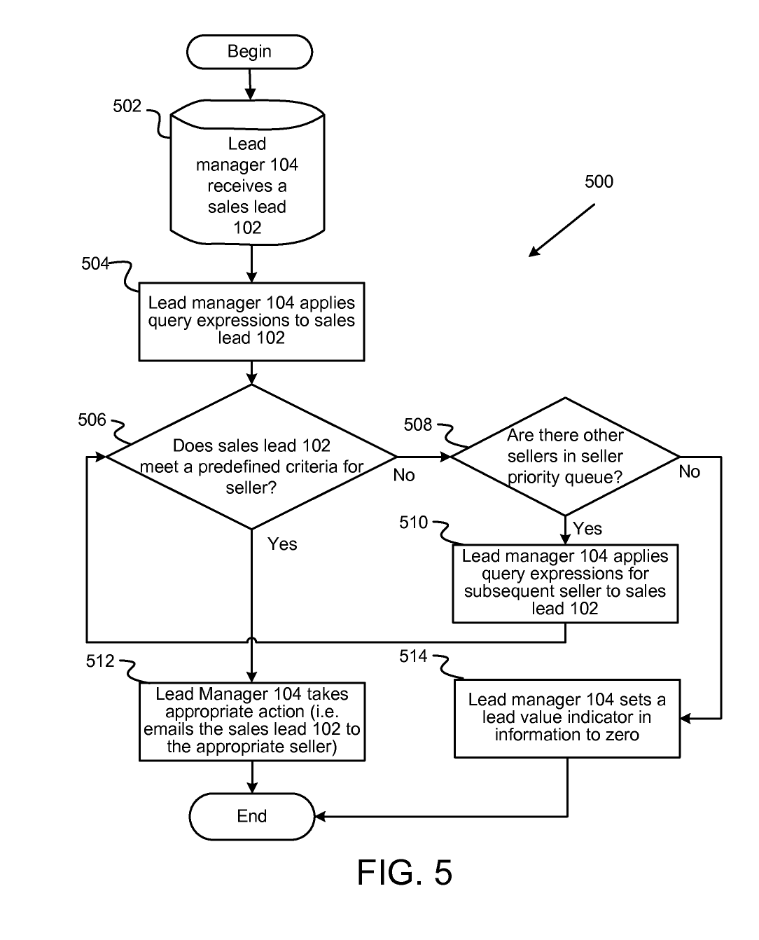

Referring now to FIG. 5, a method 500 for managing and filtering sales leads. FIGS. 5 is a flow chart illustrating a method of managing and filtering sales leads in accordance with one embodiment of the present invention. The method 500 substantially includes the embodiments and modules described above with regard to the apparatus and system depicted in FIGS. 1-4. The method 500 begins and the lead manager server 104 receives a sales lead 102. In this embodiment, the lead manager server 104 comprises a computer program product running on a DPD in accordance with the present invention.

The method 500 begins step 502 when the lead manager server 104 receives a sales lead 102. For example, the lead manager server 104 may receive the sales lead 102 from the Internet 110. The lead manager server 104 stores the sales lead 102 in computer readable memory for application of query expressions in accordance with predetermined criteria of a plurality of seller clients ordered in a priority queue.

After receiving the sales lead, at step 504, the lead manager server 104 may apply the query expressions to the sales lead 102, preparatory to effectuating delivery of the sales lead 102 to a seller whose predefined criteria is satisfied.

If, at step 506, after application of the query expressions constituted in the predefined criteria for a particular seller client 106a, the sales lead 102 is determined to satisfy the predefined criteria for a particular seller client 106a, the lead manager server 104 takes appropriate action 512 and delivers the sales lead 102 to the seller client 106a, in this embodiment by email. The method 500 then ends.

However, if, at step 506, after application of the query expressions represented in the predefined criteria for a particular seller client 106a, the sales lead 102 fails to satisfy the predefined criteria of a particular seller client 106a, the lead manager server 104 at step 508 checks for other sellers in the priority queue with predefined criteria.

If, at step 508, the lead manager server 104 determines that there are no other seller clients 106a-c in the priority queue, the method 500 may proceed to step 514. At step 514, the lead manager server 104 sets the lead value indicator to zero. The lead manager may set the lead value indicator to zero to indicate that the sales lead 102 is not scheduled for delivery to a seller client 106a-c. After the lead manager server 104 sets the lead value indicator to zero, the method 500 may terminate. In other various embodiments, the method 500 may deliver the sales lead 102 to an alternative destination 108.

If, at step 508, the lead manager server 104 determines that there are other seller clients 106b-c in the priority queue, the method 500 may proceed to step 510. At step 510, which is similar to step 504, the lead manager server 104 may apply query expressions for the subsequent seller client 106b to the sales lead 102. After the lead manager server 104 applies the query expressions, the method 500 may return to step 506 to determine whether sales lead 102 matches the predefined criteria for the subsequent seller client 106b.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer implemented method for automatically managing and delivering sales leads to a seller of a product, the steps of said method comprising:
receiving a sales lead comprising information about a potential customer, said information comprising one or more of: age, address, gender, credit rating, email, telephone number, commercial or residential nature, title in residence, size of residence, price of residence, income, education, purchasing interests, and purchasing practices;
applying one or more query expressions to the information, the query expressions comprising a Boolean condition and one or more parameters, the parameters of each query expression being predefined by one or more of: a seller in the database, a third-party manager, and a model comprising historical analysis of previous sales leads;
randomly applying one or more random query expressions to the information, the random query expressions comprising a Boolean condition and one or more parameters defined by the third-party manager;
setting a lead value indicator associated with the sales lead in response to the sales lead satisfying one or more of: the one or more query expressions, and the one or more random query expressions; and
regulating delivery of the sales lead to one or more seller clients in response to the lead value indicator satisfying a minimum priority level.

2. The computer-implemented method of claim 1, further comprising assembling the sales lead into a sales campaign in response to the sales lead satisfying the one or more query expressions.

3. The computer-implemented method of claim 2, further comprising delivering the sales campaign to one or more seller clients in a priority queue.

4. The computer-implemented method of claim 1, wherein the step of setting a lead value indicator comprises setting a plurality of lead value indicators each associated with a different seller client in a seller client database.

5. The computer-implemented method of claim 1, further comprising determining a distance between the potential customer associated with the sales lead and a seller associated with the seller client in a seller client database.

6. The computer-implemented method of claim 1, further comprising an operation to notify one or more seller clients of the receipt of the sales lead.

7. The computer-implemented method of claim 1, further comprising applying a subsequent set of one or more query expressions to the information, the subsequent query expressions comprising a Boolean condition and one or more parameters, the parameters of each subsequent query expression being predefined by one or more of: a subsequent seller client in the priority queue, a third-party manager, or a model comprising historical analysis of previous sales leads.

8. The computer-implemented method of claim 1, further comprising systematically repeating the applying step for each seller client in a seller client database while the repeating step has not been applied for all seller clients in the seller client database until one or more query expressions are satisfied.

9. The computer-implemented method of claim 8, further comprising applying a randomizing factor to the sales leads that failed to satisfy the one or more query expressions to determine which seller client in the seller client database should receive the sales lead.

10. The computer-implemented method of claim 1, wherein the information is stored in a computer readable file on a computer readable storage device, and wherein the regulating step regulates delivery of the sales lead over a computer network.

11. A computer program product comprising a computer-readable medium having computer usable program code executable to perform operations for automatically managing and delivering sales leads to a seller of a product, the operations of the computer program product comprising:
receiving a sales lead comprising information about a potential customer, said information comprising one or more of: age, address, gender, credit rating, email, telephone number, commercial or residential nature, title in residence, size of residence, price of residence, income, education, purchasing interests, and purchasing practices;
applying one or more query expressions to the information, the query expressions comprising a Boolean condition and one or more parameters, the parameters of each query expression being predefined by one or more of: a seller in the database, a third-party manager, and a model comprising historical analysis of previous sales leads;
randomly applying one or more random query expressions to the information, the random query expressions comprising a Boolean condition and one or more parameters defined by the third-party manager;
setting a lead value indicator associated with the sales lead in response to the sales lead satisfying one or more of: the one or more query expressions, and the one or more random query expressions; and
regulate delivery of the sales lead to one or more seller clients in response to the lead value indicator satisfying a minimum priority level.

12. The computer program product of claim 11, further comprising assembling the sales lead into a sales campaign in response to the sales lead satisfying the one or more query expressions.

13. The computer program product of claim 12, further comprising delivering the sales campaign to one or more seller clients in a priority queue.

14. The computer program product of claim 11, wherein the step of setting a lead value indicator comprises setting a plurality of lead value indicators each associated with a different seller client in a seller client database.

15. The computer program product of claim 11, further comprising determining a distance between the potential customer associated with the sales lead and a seller associated with the seller client in a seller client database.

16. The computer program product of claim 11, further comprising an operation to notify one or more seller clients of the receipt of the sales lead.

17. The computer program product of claim 11, further comprising applying a subsequent set of one or more query expressions to the information, the subsequent query expressions comprising a Boolean condition and one or more parameters, the parameters of each subsequent query expression being predefined by one or more of: a subsequent seller client in the priority queue, a third-party manager, or a model comprising historical analysis of previous sales leads.

18. The computer program product of claim 11, further comprising systematically repeating the applying step for each seller client in a seller client database while the repeating step has not been applied for all seller clients in the seller client database until one or more query expressions are satisfied.

19. The computer program product of claim 18, further comprising applying a randomizing factor to the sales leads that failed to satisfy the one or more query expressions to determine which seller client in the seller client database should receive the sales lead.

20. A computer system for automatically managing and delivering sales leads to a seller of a product, the system comprising:
a reception module configured to receive a sales lead comprising information about a potential customer;
an application configured to apply one or more query expressions to the information;
a randomizing module for randomly applying one or more random query expressions to the information;
a setting module configured to set a lead value indicator associated with the sales lead in response to the sales lead satisfying one or more of: the one or more query expressions, and the one or more random query expressions; and
a regulating module configured to regulate delivery of the sales lead to one or more seller clients in response to the lead value indicator.
